(19) United States
(12) Patent Application Publication
(10) Pub. No.: US 2007/0101000 A1
(43) Pub. Date: May 3, 2007

(54) Method and apparatus for capacity planning and resourse availability notification on a hosted grid

(76) Inventors: Rhonda L. Childress, Austin, TX (US); Catherine Helen Crawford, Bedford, NH (US); David Bruce Kumhyr, Austin, TX (US); Neil R. Pennell, Cedar Creek, TX (US); Christopher Daniel Reech, Austin, TX (US)

Correspondence Address: IBM CORP (YA);C/O YEE & ASSOCIATES PC, P.O. BOX 802333, DALLAS, TX, 75380, US

(21) Appl. No.: 11/264,705

(22) Filed: Nov. 1, 2005

(51) Int. Cl. G06F 15/173

(52) U.S. Cl. 709/226

(57) ABSTRACT

A computer implemented method, apparatus and computer usable program code for dynamically changing allocation policy in a host grid to support a local grid. The host grid is operated according to a set of allocation policies. The set of allocation policies corresponds to a predetermined resource allocation relationship between the host grid and a local grid. Based on the set of allocation policies, at least one resource on the host grid is allocated to the local grid. A monitoring agent is then used to monitor one of the local grid and both the local grid and the host grid for a change in a parameter. A change in the parameter may result in a change in the set of allocation policies.

### BACKGROUND OF THE INVENTION

1. Field of the Invention

The present invention relates generally to an improved data processing system and in particular to a computer implemented method and apparatus for processing data. Still more particularly, the invention relates to capacity planning and resource availability notification on a hosted grid.

2. Description of the Related Art

Modern data processing environments at times require additional resources to handle temporary increases in workload. For example, a bank may experience unusually high electronic business traffic for a period of hours, days, or longer. During these times, the bank's data processing environment may become slow or may fail to process some transactions, resulting in loss of efficiency, errors, or business opportunity. While a business may wish to avoid these undesirable outcomes, adding additional data processing capability often is cost inefficient relative to the frequency of high traffic.

To resolve this problem, some businesses enter into a contract with a provider to provide additional data processing resources when needed. The customer business usually pays a hosting fee to maintain the availability of data processing resources. The customer also pays an additional fee for the actual use of host resources, such as data processing resources, as they are used. Thus, the customer pays a hosting or maintenance fee and a “pay-as-you-go” or “on demand” fee when using the host resources. The collection of resources both in the local customer data processing environment as well as a remote hosted data processing environment can combine to form a single global data processing grid.

In general, grid computing is a form of networking data processing systems to facilitate the aggregation of computing power. Grid computing may harness unused processing cycles of all data processing systems in a network for solving problems too intensive for any one stand-alone data processing system. An example of this type of data processing grid is the Deep Computing Capacity on Demand (DCCOD) center in Poughkeepsie, New York. Customers can use the DCCOD grid to off-load work that cannot be accomplished on their own local data processing environment. Such customers only use this capacity when their own facilities cannot handle the workload required by a change in business process, by added users, by additional requirements on established workloads or the by addition of workloads.

A hosted grid provider, or vendor, must be able to predict the type, amount, and configuration of resources that should be made available to a particular customer at a particular time. However, by the nature of the contractual “pay-as-you-go” arrangement, the hosted grid provider may not know precisely what resources, the amount of resources, or the configuration of resources needed until the customer calls upon the vendor for the additional resources. For instance, a customer may ask for capacity to host an application at a specified throughput for a specified number of hours at a specified time. A customer may further specify the configuration, such as the operating system, middleware, storage, and other hardware and software that is to be present on any part of the facility tasked to executing the workload. The provider is faced with the problem of predicting these requirements and requests far enough in advance to provide the required services in a timely manner. The problem is exacerbated by the fact that the vendor typically provides similar services to many different customers, each of whom uses a variable amount of the vendor's resources at any given time. Thus, the vendor also has the problem of planning how many resources to allocate to the host grid, or host data processing grid, for customers of a given class. This type of planning may be referred to as capacity planning.

In the past, yield management systems performed capacity planning by monitoring the current activity of the host grid and by monitoring customer-reported expected activity. For example, a customer contract may have specified an expected amount of activity over a specified period of time or that a minimum level of resources was to be made available by the vendor when a request is made. In turn, the host grid would be configured according to the current usage as judged by CPU cycles used, storage usage, network traffic, other factors, and the customer-reported predicted requirements.

However, yield management systems that use this method only account for current hosted usage and for a given, predicted set of resources for a known amount of time and typically at rather coarse grain time frames, such as from weeks to months. Thus, older management systems do not provide for a rapid change in the needs of the customer. In addition, older management systems do not allow for external monitoring in which continual and dynamic update of customer usage patterns both within the hosted site as well as on the customer site is possible. This type of statistical collection is required for more rapid and more accurate prediction of resource requirement, and to prevent over-allocation of resources. Finally, older management systems do not allow for monitoring of customer usage both within the hosted site and at the customer site, which would also provide for more accurate host grid provisioning. Thus, it would be advantageous to have computer implemented methods and devices for monitoring customer usage in a global data processing grid and for dynamically adjusting host grid provisioning.

### SUMMARY OF THE INVENTION

The aspects of the present invention provides a computer implemented method, apparatus and computer usable program code for dynamically changing allocation policy in a host grid to support a local grid, or local data processing grid. The host grid is operated according to a set of allocation policies. The set of allocation policies corresponds to a predetermined resource allocation relationship between the host grid and a local grid. Based on the set of allocation policies, at least one resource on the host grid is allocated to the local grid. A monitoring agent is then used to monitor one of the local grid and both the local grid and the host grid for a change in a parameter. A change in the parameter may result in a change in the set of allocation policies. In the present invention, the host grid has a set of resources and includes at least one data processing system. The local grid includes at least one data processing system and is connected to the host grid via a network.

### BRIEF DESCRIPTION OF THE DRAWINGS

The novel features believed characteristic of the invention are set forth in the appended claims. The invention itself, however, as well as an illustrative mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system in which aspects of the present invention may be implemented;

FIG. 3 is a block diagram of a global data processing grid, including a local data processing environment and a host data processing environment, in accordance with an illustrative embodiment of the present invention; and

FIG. 4 is a flowchart of the operation of a monitoring agent for a local grid, in accordance with an illustrative embodiment of the present invention.

### DETAILED DESCRIPTION OF THE PREFERRED EMBODIMENT

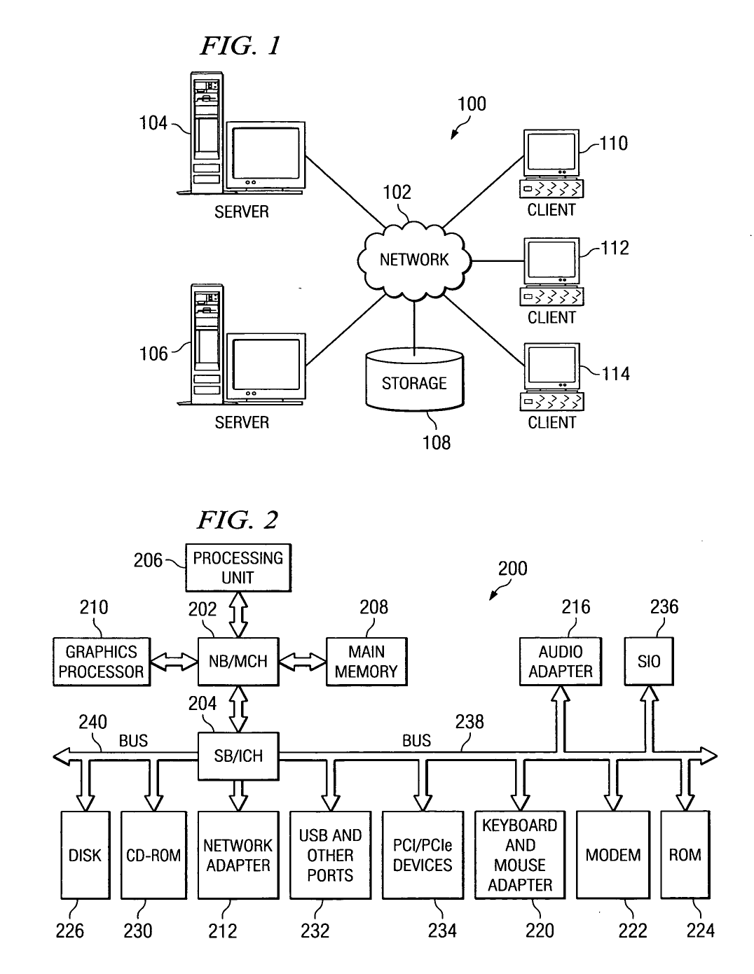

FIGS. 1-2 are provided as exemplary diagrams of data processing environments in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

A data processing grid, in general, is made up of all of the servers, clients, data stores, and network components that operate as a single data processing unit to perform a task or solve a problem. Thus a data processing grid may include clients 110, 112, and 114, server 104, all connected via network 102.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (MCH) 202 and south bridge and input/output (I/O) controller hub (ICH) 204. Processing unit 206, main memory 208, and graphics processor 210 are connected to north bridge and memory controller hub 202. Graphics processor 210 may be connected to north bridge and memory controller hub 202 through an accelerated graphics port (AGP).

In the depicted example, local area network (LAN) adapter 212 connects to south bridge and I/O controller hub 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 230. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 204 through bus 230. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM eServer™ pSeries® computer system, running the Advanced Interactive Executive (AIX®) operating system or LINUX operating system (eServer, pSeries and AIX are trademarks of International Business Machines Corporation in the United States, other countries, or both while Linux is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as hard disk drive 226, and may be loaded into main memory 208 for execution by processing unit 206. The processes for embodiments of the present invention are performed by processing unit 206 using computer usable program code, which may be located in a memory such as, for example, main memory 208, read only memory 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 230 as shown in FIG. 2. Of course the bus system may be implemented using any type of communications fabric or architecture that provides for a transfer of data between different components or devices attached to the fabric or architecture. A communications unit may include one or more devices used to transmit and receive data, such as modem 222 or network adapter 212 of FIG. 2. A memory may be, for example, main memory 208, read only memory 224, or a cache such as found in north bridge and memory controller hub 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

As described above, any of the clients, servers, data processing systems, may be connected via network to operate as a data processing grid. The mechanism of the present invention allows a host grid to be automatically, quickly, and efficiently adjusted in response to changing conditions in a local data processing environment. In addition, the mechanism of the present invention allows contract terms to be automatically, quickly, and efficiently adjusted in response to changing conditions in the local data processing environment in order to entice the customer to adjust host resource utilization.

In an illustrative example, one or more monitoring agents are used to monitor customer usage of the host grid and to monitor activity on the local data processing environment, which may be a data processing grid. Monitoring customer usage at both the host and local sites allow for the hosting service to offer additional capacity with an attractive pricing structure to hosted customers based upon customer usage patterns and predicted additional capacity. This capability benefits the hosted service, by minimizing the amount of unpaid capacity, and benefits the hosted customer, by offering additional capacity in a more timely fashion and also with a more flexible pricing structure.

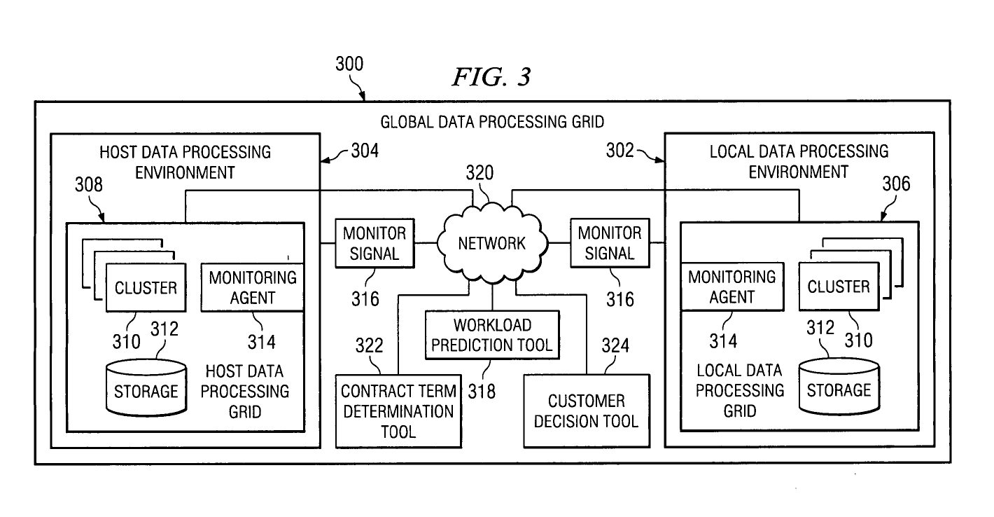

FIG. 3 is a block diagram of global data processing grid 300, including local data processing environment 302 and host data processing environment 304, in accordance with an illustrative embodiment of the present invention. Each environment includes one or more data processing grids and, optionally, other individual data processing systems or other grids. The resources that form each grid may be implemented as servers, such as server 104 in FIG. 1, or in client computers, such as clients 108, 110, and 112 in FIG. 1 or client 300 in FIG. 3, or may be other data processing resources such as routers, fax machines, printers, or other hardware or software. Host grid 308 and local grid 306 may be connected by any suitable means, including by direct connection or over a network such as network 102 in FIG. 1. Host data processing environment 308 and local data processing environment 302 form data processing grids because the individual data processing systems that make up the grids, using their client and server components, are a collective and can act as single systems to solve large problems.

Local data processing environment 302 includes local grid 306. Local grid 306 includes a plurality of data processing resources, which may include equipment such as clusters 310 of computers, storage devices 312, individual computers, printers, scanners, network connections, routers, telephones, fax machines, or any other equipment that may be used by or with data processing systems. Resources may also include software programs or any other items that are used by data processing systems to perform data processing tasks.

From time to time, local grid 306 may utilize the resources on host grid 308 within host data processing environment 304. In this illustrative example, host grid 308 provides additional resources, which may include the types of resources described in relation to local grid 306, to local grid 306 according to coded policies that are based on a contract between the customer and the host grid provider. The host grid provider provides computing, I/O, and network resources for a number of applications. The host grid provider may also host end point applications.

Thus, host grid 308 includes at least one host data processing system and the host data processing system has a set of resources. Local grid 306 includes at least one local data processing system, and local grid 306 is connected to host grid 308 via a network, such as network 320. Host grid 308 is operated according to a set of allocation policies. The set of allocation policies correspond to a predetermined resource allocation relationship between host grid 308 and a local grid. A resource allocation relationship is predetermined if the relationship has been previously created or reviewed by a human. An example of an allocation policy is a policy directed to calendaring capacity. In this case, calendaring capacity is described in terms of the time of day that resources are allocated. For example, resources are allocated from the host grid between the hours of 12:00 midnight and 5:00 a.m. central standard time five days a week in order to perform a series of batch programs. The timed allocation of resources is an allocation policy. Another example of an allocation is a fair share capacity policy. An example of such a policy is a set of commands that directs that, on average, 50% of resources on host grid 308 are dedicated to a particular customer. Another example of an allocation policy is an advanced reservation policy. An example of an advanced reservation policy is a set of commands that 10% of host grid 308 resources are started at a particular date and time. Another example of an allocation policy is a deadline scheduling policy. An example of a deadline scheduling policy is a set of commands that provide whatever host grid 308 resources that are needed in order to ensure that an application completes a task by a particular date and time. In the illustrative embodiments, these policies also reflect that the capacity is being added to another grid, such as local grid 306.

Based on the set of allocation policies, at least one resource on host grid 308 is allocated to local grid 306. A monitoring agent is then used to monitor one of all local grids and both all local grids and host grid 308 for a change in a parameter. A change in the parameter may result in a change in the set of allocation policies or priorities.

Monitoring agent 314 is installed in local grid 306 so that host grid 308 will be capable of predicting effectively the type, configuration, and amount of resources to be provided to local grid 306. Monitoring agent 314 may be software or hardware designed to monitor activity on local grid 306 and to monitor the type, configuration, and number of resources available on local grid 306.

Monitoring agent 314 generally is loaded onto local data processing environment 302 and usually is loaded onto local grid 306. However, monitoring agent 314 may be loaded in other locations, such as, for example, on a server data processing system within host grid 308 or may be loaded on a third data processing grid not shown in FIG. 3. The third data processing grid may be specifically designed to provide the monitoring functions described below vis-à-vis host grid 308 and local grid 306. Monitoring agent 314 may also be loaded on host grid 308 and may also monitor host grid 308. Thus, monitoring agent 314 may also be a means for predicting a configuration of local grid 306. Monitoring agent 314 may also be a means for predicting a configuration of host grid 308. Other means for predicting a configuration of either local grid 306 or host grid 308 may also be used, such as software programs, data processing systems, or independent clusters or grids.

Wherever monitoring agent 314 is loaded, monitoring agent 314 monitors activity and parameters on local grid 306. For example, monitoring agent 314 may monitor one or more of the number of transactions taking place on local grid 306, the type, configuration, and number of resources currently used on local grid 306, or any other parameter specified by the host grid provider or by the customer. Monitoring agent 314 generates data representing the monitored activities and is adapted to transmit the data to other components of local grid 306 and host grid 308. An example of monitoring agent 314 is that from the Globus Toolkit®, provided by Globus Alliance or a daemon from LoadLeveler®, provided by International Business Machines Incorporated. Monitoring agent 314 also may be implemented using some combination of these agents, along with other agents available in the marketplace.

In real time, or periodically, monitoring agent 314 provides monitor signal 316 to workload prediction tool 318. In this illustrative example, monitor signal 316 is transmitted via network 320. In these illustrative examples, monitor signal 316 contains data representing monitored activities, as described in the preceding paragraph.

Workload prediction tool 318 may be, for example, a separate data processing system, a separate data processing grid, a part of host grid 308, a software program installed in a computer readable medium, a component of monitoring agent 314 itself, or any other suitable hardware or software. Workload prediction tool 318 predicts the expected workload based on the information contained in monitor signal 316 from local grid 306, such as by comparing the number of transactions and available resources. Workload prediction tool 318 optionally also predicts the expected workload based on the customer-reported expected workload on host grid 308, the past workload on host grid 308 at corresponding times in the past, and on other factors that may apply to a particular contractual arrangement like events that automatically trigger a request such as cyclical workload schedules.

Based on the predicted workload, host grid 308 is adjusted to accommodate an expected change in demand for host grid resources by local grid 306. In an illustrative embodiment, the process of adjusting host grid 308 is automatic, though a user may manually adjust host grid 308. Automatic adjustments to host grid 308 may be implemented by transmitting a policy signal from workload prediction tool 318 to host grid 308 via network 320. The policy signal contains information regarding how host grid 308 should be configured vis-à-vis a particular customer at local grid 306. Host grid 308 makes adjustments to the host resources available to local grid 306 based on the enumerated policies, thereby adjusting the configuration of host grid 308. The means for configuring the host data processing system may be a host control system that takes the form of one or more data processing systems, software programs, users, or data processing grids.

Thus, monitoring agent 314 allows host grid 308 to adjust to a change in local grid 306 quickly and efficiently without exceeding limits set by a particular contractual agreement. If allowed by a prior agreement, the adjustment may take place in the absence of a request by local grid 306 in order that host grid 308 may more quickly react to the changing needs of local grid 306.

In emergencies, host grid 308 may be automatically adjusted to handle the exigent requirements of a local grid without a prior agreement in place. In this case, new contract terms may be determined automatically and quickly, as described further below, to accommodate the new business circumstance.

As described above, changes to host grid 308 can be made in advance of an actual demand by local grid 306, depending on data collected by monitoring agent 314. For example, if monitoring agent 314 detects that the resources of a local grid are operating at 95 percent capacity, then local grid 306 can be adjusted before local grid 306 begins using host grid resources, assuming local grid 306 uses host grid resources after exceeding 100 percent capacity.

How far in advance changes to host grid usage may be predicted depends on the nature of the activity supported by local grid 306 and host grid 308, the information collected, the tolerance policies of local grid 306 and host grid, and other factors or other set policies. Changes in demand may be predicted and made within a few seconds to a few days, though generally within two to four hours.

Unlike prior systems for automatically adjusting pricing and grid operational policies in the face of changes in demand, the monitoring solution of the present invention provides an event to local and hosted data centers, based on what monitoring agent 314 detects from the existing systems going in and out of expected parameters. Thus, the mechanism of the present invention allows a host to tailor contract offers, grid operating policies, and host grid resources to specific individual customers based on their separate needs and on any conditions that are unique to a particular customer. In addition, the mechanism of the present invention allows for a host grid to be adjusted even before a change in demand occurs. Moreover, the mechanism of the present invention allows for contract terms to be generated even in the absence of a pre-existing agreement.

In an illustrative example, local grid 306 may be a data center handling Internet transactions for a bank. In this example, the data center begins to slow in response to an unusually high amount of Internet business activity. Monitoring agent 314 detects the high level of activity and the slowdown. In response, monitoring agent 314 sends monitor signal 316 to workload prediction tool 318. Monitor signal 316 may include information such as the level of activity, the amount of slow-down, the current resources available to local grid 306, and other information.

In response, workload prediction tool 318 determines that local grid 306, given the current pattern of workload, may require five additional servers over time. Prior contractual agreements, however, stipulate that no more than four servers can be added at this time. The additional servers, each running three software programs, provide enough capacity to reasonably handle the overflow of Internet business activity. In response, host grid 308 changes its operating policy to automatically configure four servers with the required software programs and automatically ensures that these additional resources are configured to operate correctly in concert with local grid 306. The customer is then charged for the use of these resources, based on the customer's particular contractual agreement.

In this example, an optimal or better resource allocation which includes five servers, where the set of allocation policies only allows four servers, violates the set of allocation policies. In addition, in this example, a parameter monitored by monitoring agent 314 includes at least the workload on local grid 306. The use of five servers by local grid 306 is optimal relative to the use of four servers by local grid 306. As used herein, the term “optimal” means a better configuration of resources utilized by a local grid, such as local grid 306, than the current best possible configuration of utilized resources allowed under the current set of allocation policies. Thus, the better configuration of utilized resources may be referred to as “more optimal” than the current best possible configuration of utilized resources. Additionally, the host grid may also be monitored for parameters that affect local grid resource utilization. Accordingly, a monitoring agent may be used to monitor one of the local grid and both the local grid and the host grid for a change in a parameter. The change in the parameter indicates an optimal resource allocation which would violate the set of allocation policies.

Continuing the example, the unusually high Internet activity eventually reduces to a normal amount of Internet activity. Monitoring agent 314 detects the decrease in Internet activity and sends monitor signal 316 to workload prediction tool 318. In response, workload prediction tool 318 creates a new operating policy that causes host grid 308 to no longer make available the servers and software programs to local grid 306. These resources are then available to another customer.

In addition to making additional resources available to local grid 306, the mechanism of the present invention also provides a means for notifying a customer to utilize resources on host grid 308 if those resources are underutilized and could be consumed by a customer at a reduced rate, or to avoid an anticipated problem, or to detect a mismatch between the customer's workload patterns and prior contractual agreements.

As described in relation to providing resources, monitoring agent 314 monitors local grid 306 and transmits monitor signal 316 to workload prediction tool 318. However, workload prediction tool 318 also provides information regarding the predicted workload to contract term determination tool 322. Contract term determination tool 322 may be a separate data processing system, a separate data processing grid, a part of host grid 308, a software program installed in a computer readable medium, a component of monitoring agent 314 itself, any other suitable hardware or software, or optionally a human decision maker. Contract term determination tool 322 uses information, such as workload measurements and storage consumption patterns, generated by monitoring agent 314 to determine adjustments to the price and the terms of making host grid resources available to local grid 306.

In turn, contract term determination tool 322 sends a signal containing data relevant to the change in contract terms to customer decision tool 324. Customer decision tool 324 may be a separate data processing system, a separate data processing grid, a part of host grid 308, a software program installed in a computer readable medium, a component of monitoring agent 314 itself, or any other suitable hardware or software. Alternatively, a notification can be sent to a user interface for accepting a user input regarding acceptance or refusal of the new contract.

Based on the offered change in contract terms or the offered additional contracts, customer decision tool 324 may cause local grid 306 to transmit a request signal to host grid 308. For example, customer decision tool 324 can receive information about additional capacity, and also receive information based on prediction techniques to see if the additional capacity is required. Customer decision tool 324 then allows an administrator to send a standards-based resource allocation request into host grid 308 to obtain the new resources as needed. The request signal may be generated and sent automatically based on policies established by the operator of local grid 306. For example, local grid 306 monitors offered contract changes and determines whether to accept offered changes by comparing the offer to coded contract terms. Thus, if the contract offer falls within a range of prices and other terms specified by a predetermined policy, then the contract offer is accepted; otherwise, the contract offer is refused or decision on the offer is delayed until a user can review the offer. A predetermined policy is a policy that has been previously created or reviewed by a human.

Whenever a change in contract terms is accepted, the request signal effectively requests a change in resource utilization on host grid 308. A request signal includes resource specification characteristics, such as computer CPU architecture, memory requirements, operating system version, as I/O resources, and any other resource specification characteristics or other resource requirements. The operating policy on host grid 308 is then adjusted accordingly.

In another illustrative example, monitoring agent 314 detects unusually high Internet activity on the bank's local grid 306. However, perhaps due to cost considerations or due to the current contract terms, local grid 306 does not request additional resources from host grid 308. Local grid 306 has access to information regarding current cost and contract terms because local grid 306 and host grid 308 share the same contract data and act in concert accordingly. The agent transmits monitor signal 316 to workload prediction tool 318. In turn, contract term determination tool 322 receives information from workload prediction tool 318, or receives information directly from monitor signal 316. In response, depending on current overall host grid resource utilization, contract term determination tool 322 may automatically lower the price of utilizing resources on host grid 308. Information regarding the lowered price is transmitted via a signal to customer decision tool 324 in order to entice the customer to request utilization of resources on host grid 308.

In another example, monitoring agent 314 detects an increase in Internet activity and, as a result, local grid 306 utilizes resources on host grid 308, as described above. However, host grid 308 becomes overloaded due to high demand for resources on host grid 308. In response, contract term determination tool 322 increases the price for utilizing resources on host grid 308. In turn, the notification for recommended change in contract terms is transmitted to customer decision tool 324 in order to entice the customer to use fewer resources on host grid 308.

Thus, the mechanism of the present invention allows host grid 308 to be adjusted automatically, quickly, and efficiently in response to changing conditions in local data processing environment 302. The mechanism of the present invention can be used to manage specific data processing systems and specific versions of software operating on individual data processing systems. In addition, the mechanism of the present invention allows contract terms to be adjusted automatically, quickly, and efficiently in response to changing conditions in local data processing environment 302. Thus, the mechanism of the present invention allows automatic configuration of a host grid in response to monitored changes in a local grid. The present invention also provides a mechanism to entice the customer to adjust host resource utilization.

In another illustrative example, additional customers having additional local grids utilize resources on host grid 308. In this case, monitoring agents are loaded in each local grid, and a monitoring agent may also be loaded in host grid 308. As time progresses, the number, type, and configuration of host grid resources that each local grid uses changes. For example, a first local grid may use more resources at time 1 and fewer resources at time 2 whereas a second local grid may use more resources at time 2 and less at time 1. The mechanism of the present invention can also be used to manage host grid usage by multiple local grids.

In this illustrative example, when the resources of local grid 306 become taxed by the combined usage of all other local grids, contract determination tool 322 on host grid 308 may transmit signals to customer decision tool 324 at each of the local grids. Each signal indicates that each customer will receive a reduced rate for access to host services for those customers that time shift use of resources. Thus, those customers that are conducting less critical functions will be enticed to delay use of host grid resources until a future time. Customer decision tool 324 in each local grid transmits corresponding response signals to host grid 308, which then changes its operating policies to provide additional resources to accommodate priority jobs and to provide less or no resources to time-shifted jobs. The transmission of policies and agreements back and forth between host grid 308 and local grid 306 may be performed automatically, as described above.

In other illustrative examples, the host provider may also universally raise the price of access to host resources (to the extent allowed by contract) in order to reduce the workload burden on host grid 308. The host provider may also charge different customers different amounts under different terms, based on conditions unique to each customer, such as customer contract terms or specific technical aspects related to the cost of providing service to a specific customer. Thus, a dynamic interplay between host grid 308 and each local grid may take place wherein host grid 308 dynamically and actively adjusts operating policies based on the changing needs and desires of different customers.

As a result, the present invention provides for a computer implemented method of dynamically changing allocation policy in a host grid to support a local grid. Changing the set of allocation polices or priorities may include adjusting at least one of a type of resource on the host grid, a configuration of a resource on the host grid, and a number of resources on the host grid. Adjusting at least one of a type of resource may involve adjusting one or more of the type of resources. Furthermore, resource types other than those in the illustrative examples may be adjusted.

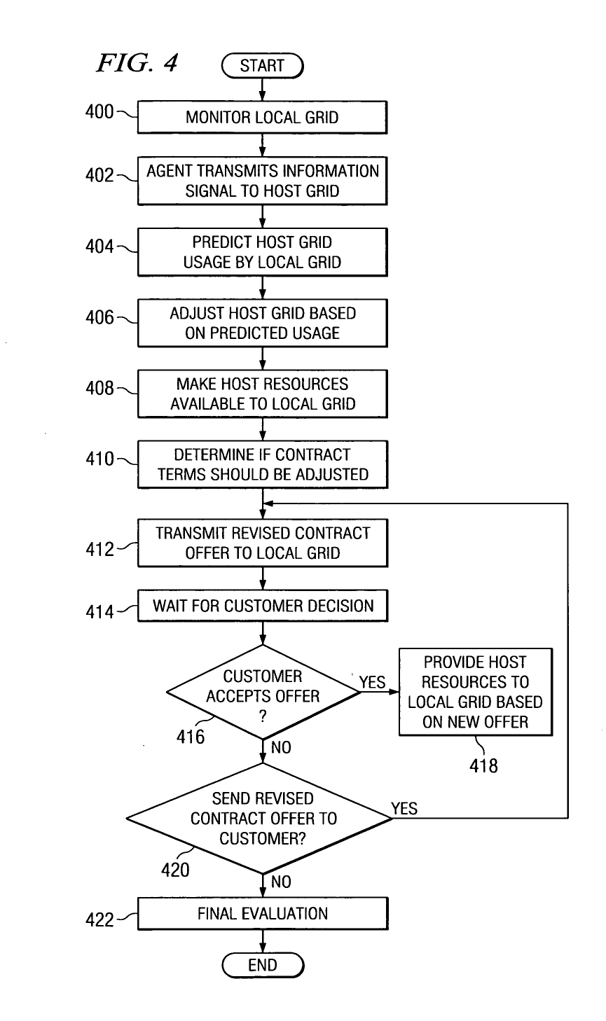

FIG. 4 is a flowchart of the operation of a monitoring agent for a local grid, in accordance with an illustrative embodiment of the present invention. The method shown in FIG. 4 may be implemented in a data processing grid, such as global data processing grid 300 in FIG. 3.

The process begins as a monitoring agent monitors a local grid (step 400). The monitoring agent may monitor activity on the local grid, and may also monitor the type, configuration, and number of resources on the local grid. Next, the monitoring agent transmits an information signal, such as monitor signal 316 in FIG. 3, to the host data processing environment (step 402). The information signal includes information regarding the type, configuration, and number of resources on the local grid. The information signal also includes information regarding the current workload of the local grid.

Thereafter, a workload prediction tool predicts the type, configuration, and amount of resources needed by the local grid (step 404). In response, the host grid is adjusted based on the parameters defined by the prior contract and based on the predicted host usage (step 406). Adjusting the host grid includes setting up additional resources, optimizing currently available resources, configuring resources, deleting resources, and performing other adjustments to the host grid. The resources on the host grid are then made available to the local grid (step 408). To this point, any adjustments to the host grid are made according to policies predetermined by an existing contract.

The monitoring agent continues to monitor activity on the local grid and to provide activity information to the host grid, and particularly to the contract term determination tool. The contract term determination tool evaluates host grid usage by the local grid and determines whether existing contract terms should be adjusted or new contracts created (step 410), as described in relation to FIG. 3. For example, if the host grid is underutilized, then the contract term determination tool may transmit a reduction in price for use of the host grid's resources. Alternatively, if the host grid is over utilized, then the contract term determination tool may transmit an increase in price for use of the host grid's resources.

The contract term determination tool may then cause a revised contract offer to be transmitted to the customer decision tool, as described in relation to FIG. 3 (step 412). The revised contract offer may include lowering a unit price, or a cost per computational unit, to utilize resources on the host grid, or any terms likely to increase utilization of the host grid.

Thereafter, the contract term determination tool waits for a time to allow the customer decision tool to make a decision regarding the revised contract terms (step 414). Thereafter, a determination is made whether the customer accepted the revised contract (step 416). If the customer accepted the revised contract, then the host grid continues to provide resources to the local grid according to the new contract terms (step 418).

If the customer refuses the new contract offer or fails to accept the new contract offer, then the contract term determination tool determines whether a revised contract offer should be sent (step 420). The new offer may include a further reduction in price to entice the customer to increase usage of the host grid resources. The new offer may also indicate that the contract will be canceled, and host grid resources not provided, if the customer does not accept a higher price. Any other new offer may be sent to the customer that is specifically tailored to the customer's needs and the host provider's currently available resources. The process then returns to step 412, where the revised offer is transmitted to the customer and is evaluated. If the customer then rejects the revised offer in step 416, then the process may repeat if the contract term determination tool evaluates that a third, fourth, or additional contract offers should be transmitted to the customer.

Returning to step 420, if the contract term determination tool evaluates that a revised offer should not be sent to the customer, then the contract term determination tool makes a final evaluation as to how host grid resources should be provided to the customer's local grid (step 422). In one illustrative example, the contract term determination tool evaluates that the current contract is still in force and will not be modified. In this case, the host grid resources continue to be provided to the customer local grid without modifications. In another illustrative example, the contract term determination tool evaluates that the current contract is to be canceled or modified unilaterally. In this case, fewer or no host grid resources are available to the customer local grid.

The process shown in FIG. 4 may be repeated as long as the customer and the vendor desire to maintain a relationship with each other for the purpose of providing resources from the host grid to the local grid. The process may terminate at any step if either the customer or the provider decides to terminate the overall contractual relationship. Nevertheless, the host provider may continue to offer new contract terms to the customer decision tool on the local grid in an attempt to entice a prior customer to re-utilize host grid resources. Examples of the negotiation process between the host provider and the customer are described in relation to FIG. 3.

In addition, the set of allocation policies reflect a contract between a host organization operating the host grid and a customer organization operating the local grid. Furthermore, the proposed change in the set of allocation policies is associated with a change in the contract.

Thus, the present invention provides a computer implemented method, apparatus and computer usable program code for dynamically monitoring a local grid and, responsive to a change in that grid, adjusting a host grid. In addition, the contractual relationship between the vendor and the customer may be dynamically monitored and adjusted in response to a change in the local grid.

The mechanism of the present invention provides substantial advantages over prior methods of predicting use of resources on the host grid. For example, the prior method of predicting use of resources on the host grid only monitored the host grid and customer-reported expected use. However, the mechanism of the present invention directly monitors the local grid and activity on the local grid, and may also monitor current and past host grid utilization and customer-predicted future utilization. Thus, the mechanism of the present invention allows a host grid to be rapidly adjusted in response to changing conditions on the local grid. As a result, the host grid is better able to respond to customer needs. Furthermore, the host provider is better able to determine what resources need to be provided to the host grid.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method of dynamically changing allocation policy in a host grid to support a local grid, the computer implemented method comprising:
operating the host grid according to a set of allocation policies, wherein the set of allocation policies correspond to a predetermined resource allocation relationship between the host grid and a local grid, wherein the host grid comprises at least one host data processing system and wherein the host data processing system has a set of resources, wherein the local grid comprises at least one local data processing system, and wherein the local grid is connected to the host grid via a network;
based on the set of allocation policies, allocating at least one resource on the host grid to the local grid; and
using a monitoring agent to monitor one of the local grid and both the local grid and the host grid for a change in a parameter, wherein the change in the parameter indicates a more optimal resource allocation which would violate the set of allocation policies.

2. The computer implemented method of claim 1 further comprising:
responsive to detecting the change in the parameter, changing the set of allocation policies to create a set of changed allocation policies.

3. The computer implemented method of claim 1 further comprising:
responsive to detecting the change in the parameter, transmitting a proposed change in the set of allocation policies to a customer decision tool loaded on the local grid; and
responsive to receipt of an acceptance from the customer decision tool to the proposed change, changing the set of allocation policies according to the proposed change to create a set of changed allocation policies.

4. The computer implemented method of claim 1 wherein the step of monitoring is performed using a monitoring agent.

5. The computer implemented method of claim 4 wherein the monitoring agent is loaded in the local grid.

6. The computer implemented method of claim 2 wherein changing the set of allocation policies comprises:
adjusting at least one of a type of resource on the host grid, a configuration of a resource on the host grid, and a number of resources on the host grid.

7. The computer implemented method of claim 1 wherein step of monitoring further comprises:
monitoring at least one of an activity on the local grid, a type of resource present on the local grid, a configuration of a resource on the local grid, and a number of resources present on the local grid.

8. The computer implemented method of claim 1 wherein the parameter is generated by a workload prediction tool.

9. The computer implemented method of claim 3 wherein the set of allocation policies reflect a contract between a host organization operating the host grid and a customer organization operating the local grid and the proposed change in the set of allocation policies is associated with a change in the contract.

10. A method in a data processing environment, said method comprising:
monitoring a parameter in a local grid;
responsive to a change in the parameter, predicting a configuration that the local grid could request of a host grid, wherein data representing a predicted configuration is generated;
transmitting the data to the host grid; and
responsive to the data, offering a customer a new contract to utilize the host grid.

11. The method of claim 10 further comprising configuring the host grid in response to the customer accepting the new contract.

12. The method of claim 10 further comprising offering a second new contract in response to the customer not accepting the new contract.

13. A computer program product comprising:
a computer usable medium for dynamically changing allocation policy in a host grid to support a local grid, said computer program product including:
computer usable program code for operating the host grid according to a set of allocation policies, wherein the set of allocation policies correspond to a predetermined resource allocation relationship between the host grid and a local grid, wherein the host grid comprises at least one data processing system and wherein the host data processing system has a set of resources, wherein the local grid comprises at least one data processing system, and wherein the local grid is connected to the host grid via a network;
computer useable program code for, based on the set of allocation policies, allocating at least one resource on the host grid to the local grid; and
computer usable program code for using a monitoring agent to monitor one of the local grid and both the local grid and the host grid for a change in a parameter, wherein the change in the parameter indicates a more optimal resource allocation which would violate the set of allocation policies.

14. The computer program product of claim 13 further comprising:
computer usable program code for, responsive to detecting the change in the parameter, changing the set of allocation policies to create a set of changed allocation policies.

15. The computer program product of claim 13 further comprising:
computer usable program code for, responsive to detecting the change in the parameter, transmitting a proposed change in the set of allocation policies to a customer decision tool loaded on the local grid; and
computer usable program code for, responsive to receipt of an acceptance from the customer decision tool to the proposed change, changing the set of allocation policies according to the proposed change to create a set of changed allocation policies.

16. The computer program product of claim 13 wherein the computer usable program code for monitoring is a monitoring agent.

17. The computer program product of claim 16 wherein the monitoring agent is loaded in the local grid.

18. The computer program product of claim 13 wherein the computer usable program code for changing the set of allocation policies comprises:
computer usable program code for adjusting at least one of a type of resource on the host grid, a configuration of a resource on the host grid, and a number of resources on the host grid.

19. The computer program product of claim 13 wherein computer usable program code for monitoring further comprises:
computer usable program code for monitoring at least one of an activity on the local grid, a type of resource present on the local grid, a configuration of a resource on the local grid, and a number of resources present on the local grid.

20. The computer program product of claim 13 wherein the parameter is generated by a workload prediction tool.

21. The computer program product of claim 15 wherein the set of allocation policies reflect a contract between a host organization operating the host grid and a customer organization operating the local grid and the proposed change in the set of allocation policies is associated with a change in the contract.

22. A computer program product comprising:
a computer usable medium for dynamically creating a new contract, said computer program product including:
computer usable program code for monitoring a parameter in a local grid;
computer usable program code for, responsive to a change in the parameter, predicting a configuration that the local grid could request of a host grid, wherein data representing a predicted configuration is generated;
computer usable program code for transmitting the data to the host grid; and
computer usable program code for, responsive to the data, offering a customer a new contract to utilize the host grid.

23. The computer program product of claim 22 further comprising:
computer usable program code for configuring the host grid in response to the customer accepting the new contract.

24. The computer program product of claim 22 further comprising:
computer usable program code for offering a second new contract in response to the customer not accepting the new contract.

25. A data processing system for dynamically changing allocation policy in a host grid to support a local grid, the data processing system comprising:
a bus;
a memory operably connected to the bus, wherein the memory contains a computer usable program code;
a processor operably connected to the bus, wherein the processor is adapted to execute the computer usable program code to operate the host grid according to a set of allocation policies, wherein the set of allocation policies correspond to a predetermined resource allocation relationship between the host grid and a local grid, wherein the host grid comprises at least one host data processing system and wherein the host data processing system has a set of resources, wherein the local grid comprises at least one local data processing system, and wherein the local grid is connected to the host grid via a network; allocate at least one resource on the host grid to the local grid based on the set of allocation policies; and use a monitoring agent to monitor one of the local grid and both the local grid and the host grid for a change in a parameter, wherein the change in the parameter indicates a more optimal resource allocation which would violate the set of allocation policies.

26. The data processing system of claim 25 wherein the processor further executes the computer usable program code to change the set of allocation policies to create a set of changed allocation policies in response to detecting the change in the parameter.

27. The data processing system of claim 25 wherein the processor further executes the computer usable program code to transmit a proposed change in the set of allocation policies to a customer decision tool loaded on the local grid responsive to detecting the change in the parameter; and change the set of allocation policies according to the proposed change to create a set of changed allocation policies responsive to receipt of an acceptance from the customer decision tool to the proposed change.

28. The data processing system of claim 25 wherein the processor further executes the computer usable program code to monitor using a monitoring agent.

29. The data processing system of claim 28 wherein the processor further executes the computer usable program code to load the monitoring agent in the local grid.

30. The data processing system of claim 26 wherein the processor further executes the computer usable program code to change the set of allocation policies by adjusting at least one of a type of resource on the host grid, a configuration of a resource on the host grid, and a number of resources on the host grid.

31. The data processing system of claim 25 wherein the processor further executes the computer usable program code to monitor at least one of an activity on the local grid, a type of resource present on the local grid, a configuration of a resource on the local grid, and a number of resources present on the local grid.

32. The data processing system of claim 25 wherein the processor further executes the computer usable program code to generate the parameter with a workload prediction tool.

33. The data processing system of claim 27 wherein the processor further executes the computer usable program code such that the set of allocation policies reflect a contract between a host organization operating the host grid and a customer organization operating the local grid and the proposed change in the set of allocation policies is associated with a change in the contract.

34. A data processing system for creating a new contract, the data processing system comprising:
a bus;
a memory operably connected to the bus, wherein the memory contains a computer usable program code;
a processor operably connected to the bus, wherein the processor is adapted to execute the computer usable program code to monitor a parameter in a local grid; predict a configuration that the local grid could request of a host grid responsive to a change in the parameter, wherein data representing a predicted configuration is generated; transmit the data to the host grid; and offer a customer a new contract to utilize the host grid responsive to the data.

35. The data processing system of claim 34 wherein the processor further executes the computer usable program code to configure the host grid in response to the customer accepting the new contract.

36. The data processing system of claim 34 wherein the processor further executes the computer usable program code to offer a second new contract in response to the customer not accepting the new contract.
